(19) United States
(12) Patent Application Publication
(10) Pub. No.: US 2026/0238105 A1
(43) Pub. Date: Aug. 13, 2026

(54) VIBRATION EXCITER

(71) Applicant: MERRY ELECTRONICS (SUZHOU) CO., LTD., Suzhou City (CN)

(72) Inventors: Jiawei ZHU, Suzhou City (CN); Mingya LUO, Suzhou City (CN)

(73) Assignee: MERRY ELECTRONICS (SUZHOU) CO., LTD., Suzhou City (CN)

(21) Appl. No.: 19/206,729

(22) Filed: May 13, 2025

(30) Foreign Application Priority Data
Feb. 13, 2025 (CN) 202520228710.3
Feb. 13, 2025 (CN) 202520228743.8

(51) Int. Cl. H02K 33/02; H02K 33/18

(52) U.S. Cl. CPC H02K 33/02; H02K 33/18

(57) ABSTRACT

A vibration exciter is provided. The vibration exciter includes a housing, a magnetic circuit system, and a coil. The housing includes a housing body and a cover plate. The housing body includes a first housing portion, a second housing portion, and a cantilever structure connected between the first housing portion and the second housing portion. The cantilever structure is elastically deformable. The cover plate is connected to the second housing portion. The magnetic circuit system is disposed in the housing. The magnetic circuit system is connected to the first housing portion. The coil is disposed in the housing. One end of the coil in the axial direction of the coil is connected to the cover plate. The other end of the coil extends into the magnetic gap of the magnetic circuit system. The magnetic circuit system is configured to vibrate relative to the coil.

### CROSS-REFERENCE TO RELATED APPLICATION(S)

This application claims priority to Chinese Patent Applications No. 202520228710.3 and 202520228743.8 filed Feb. 13, 2025, the disclosures of which are incorporated herein by reference in their entireties.

### TECHNICAL FIELD

This disclosure relates to the field of exciters, particularly a vibration exciter.

### BACKGROUND

Electronic devices such as mobile phones, tablets, and handheld multimedia entertainment devices typically use exciters to provide system feedback, such as vibration feedback of mobile phones and game consoles.

In the related art, to avoid openings for producing sound, an electronic device uses the screen or the housing of the electronic device to produce sound through vibration, with an exciter being the vibration source of the screen or the housing. The exciter includes a housing and a magnetic circuit system, a coil, and an elastic member in the housing. The coil is connected to the housing and wound around the magnetic circuit system. When energized, the coil generates a magnetic field. The magnetic circuit system uses electromagnetic induction to convert electrical energy into mechanical energy. The magnetic circuit system is suspended in the housing through the elastic member. When vibrating, the magnetic circuit system can drive the housing to vibrate, achieving vibration feedback. As can be seen, the exciter in the related art requires a separate elastic member, resulting in a more complex structure with a larger number of components and thus more assembly steps and lower assembly efficiency.

### SUMMARY

An object of this disclosure is to provide a vibration exciter to solve the problem in which an exciter has a more complex structure with a larger number of components and thus more assembly steps and lower assembly efficiency in the related art.

As conceived above, the technical solution of this disclosure is as follows:

A vibration exciter includes a housing, a magnetic circuit system, and a coil. The housing includes a housing body and a cover plate. The housing body is an integral structure. The housing body includes a first housing portion, a second housing portion, and a cantilever structure connected between the first housing portion and the second housing portion. The cantilever structure is elastically deformable. The cover plate is connected to the second housing portion. The magnetic circuit system is connected to the first housing portion and suspended in the housing through the cantilever structure. The magnetic circuit system has a magnetic gap. The coil is disposed in the housing. One end of the coil in the axial direction of the coil is connected to the cover plate and the other end of the coil extends into the magnetic gap. The magnetic circuit system is configured to vibrate relative to the coil.

In an embodiment, the vibration exciter also includes a stopper. The stopper is connected to the cover plate and/or the second housing portion. The stopper is spaced apart from the magnetic circuit system and configured to restrict the magnetic circuit system from coming into contact with the coil in a characteristic direction. The characteristic direction is perpendicular to the thickness direction of the housing.

In an embodiment, the magnetic circuit system includes a magnetic yoke and a magnet.

The magnetic yoke includes a body portion and multiple extension portions. Each extension portion is connected to the body portion at an angle. The extension portions are spaced apart along the circumferential direction of the body portion. The body portion is connected to the first housing portion. The magnet is connected to the body portion. The magnet and the extension portions cooperate to form the magnetic gap. The stopper is disposed on a side of the extension portions away from the magnet. The stopper is configured to restrict the extension portions from coming into contact with the coil in the characteristic direction.

In an embodiment, the extension portions include two extension portions opposite in a second direction and two extension portions opposite in a third direction.

The stopper is annular. The extension portions are located in a ring of the stopper. The inner ring surface of the stopper is configured to come into contact with the extension portions to limit the maximum distance between the extension portions and the coil. A notch is configured for a lead-out wire of the coil to pass through.

In an embodiment, the extension portions include two first extension portions opposite in a second direction and two second extension portions opposite in a third direction, multiple stoppers are provided, two opposite sides of the two first extension portions are each provided with at least one stopper, and two opposite sides of the two second extension portions are each provided with at least one stopper.

In an embodiment, the cantilever structure includes multiple first deformable members spaced apart along the circumferential direction of the first housing portion. For each first deformable member, one end of the first deformable member is connected to the first housing portion, the other end of the first deformable member is connected to the second housing portion, and the first deformable member is elastically deformable.

In an embodiment, a connection position between the first deformable member and the first housing portion is a first connection position, a connection position between the first deformable member and the second housing portion is a second connection position, and the first connection position and the second connection position are staggered in the characteristic direction.

In an embodiment, the magnetic yoke also includes a deformable structure. The extension portions are connected to the housing by the deformable structure.

In an embodiment, the deformable structure and the extension portions are an integral structure, or the deformable structure is connected to the surface of the extension portion facing away from the coil.

In an embodiment, the vibration exciter also includes a buffer layer disposed between the magnetic circuit system and the cover plate and connected to the magnetic circuit system and/or the cover plate.

### BRIEF DESCRIPTION OF DRAWINGS

To illustrate solutions of embodiments of this disclosure more clearly, drawings used in the description of the embodiments of this disclosure are briefly described hereinafter. Apparently, the drawings described hereinafter illustrate some of the embodiments of this disclosure. Those of ordinary skill in the art may also obtain other drawings based on the content of the embodiments of this disclosure and the drawings on the premise that no creative work is done.

FIG. 1 is a first view illustrating the structure of a vibration exciter according to embodiment one of this disclosure.

FIG. 2 is a second view illustrating the structure of a vibration exciter according to embodiment one of this disclosure.

FIG. 3 is an exploded view of a vibration exciter according to embodiment one of this disclosure.

FIG. 4 is a section view of a vibration exciter according to embodiment one of this disclosure.

FIG. 5 is an exploded view of a housing body and a magnetic yoke according to embodiment one of this disclosure.

FIG. 6 is an exploded view of a vibration exciter according to embodiment three of this disclosure.

FIG. 7 is a section view of a vibration exciter according to embodiment three of this disclosure.

FIG. 8 is a view illustrating the structure of a magnetic yoke according to embodiment three of this disclosure.

FIG. 9 is an exploded view of a vibration exciter according to embodiment four of this disclosure.

FIG. 10 is a section view of a vibration exciter according to embodiment four of this disclosure.

FIG. 11 is a view illustrating the structure of a magnetic yoke according to embodiment four of this disclosure.

FIG. 12 is an exploded view of a vibration exciter according to embodiment five of this disclosure.

FIG. 13 is a section view of a vibration exciter according to embodiment five of this disclosure.

### DETAILED DESCRIPTION

To make the technical problems solved, the technical solutions used, and the technical effects achieved in this disclosure more apparent, the technical solutions of this disclosure are further described below in conjunction with the drawings and embodiments. It is to be understood that the embodiments described herein are intended to illustrate and not to limit this disclosure. Additionally, it is to be noted that for ease of description, part, not all, related to this disclosure is illustrated in the drawings.

It is to be noted that similar reference numerals and letters represent similar items in the drawings. Therefore, once an item is defined in one drawing, the item no longer needs to be defined and interpreted in the subsequent drawings.

In the description of this disclosure, unless otherwise expressly specified and limited, the term “connected to each other”, “connected”, or “secured” is to be construed in a broad sense, for example, as securely connected, detachably connected or integrated; mechanically connected or electrically connected; directly connected to each other or indirectly connected to each other via an intermediary; or internally connected or an interactional relationship between two elements. For those of ordinary skill in the art, specific meanings of the preceding terms in this disclosure may be understood based on specific situations.

In this disclosure, unless otherwise expressly specified and limited, when a first feature is described as being “on” or “below” a second feature, the first feature and the second feature may be in direct contact or be in contact via another feature between the two features instead of being in direct contact. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature. In the description of this embodiment, “multiple” means two or more unless otherwise specified.

In the description of this application, it is to be understood that the orientation or position relationships indicated by terms such as “center”, “longitudinal”, “lateral”, “length”, “width”, “thickness”, “above”, “below”, “front”, “back”,” “left”, “right”, “vertical”, “horizontal”, “top”, “bottom”, “inside”, “outside”, “clockwise”, “counterclockwise”, “axial”, “radial”, and “circumferential” are based on the orientation or position relationships shown in the drawings. These terms are intended for brief and simple description and do not indicate or imply that the device or element referred to has a particular orientation and is constructed and operated in a specific orientation. Thus, these terms cannot be construed as limiting this disclosure. In addition, the terms “first” and “second” are used for distinguishing between descriptions and have no special meaning.

It is to be noted that when a component is described as being “secured to” or “disposed on” another component, this component may be directly on the other component, or an intervening component may be on the other component.

The technical solutions of this disclosure are further described hereinafter in conjunction with the drawings and the embodiments.

### Embodiment One

This embodiment provides a vibration exciter. The vibration exciter has a simpler structure with fewer components, involving fewer assembly steps and higher assembly efficiency.

The vibration exciter of this embodiment may be applied to an electronic device such as a mobile phone, a tablet computer, or a handheld multimedia entertainment device to generate vibration feedback.

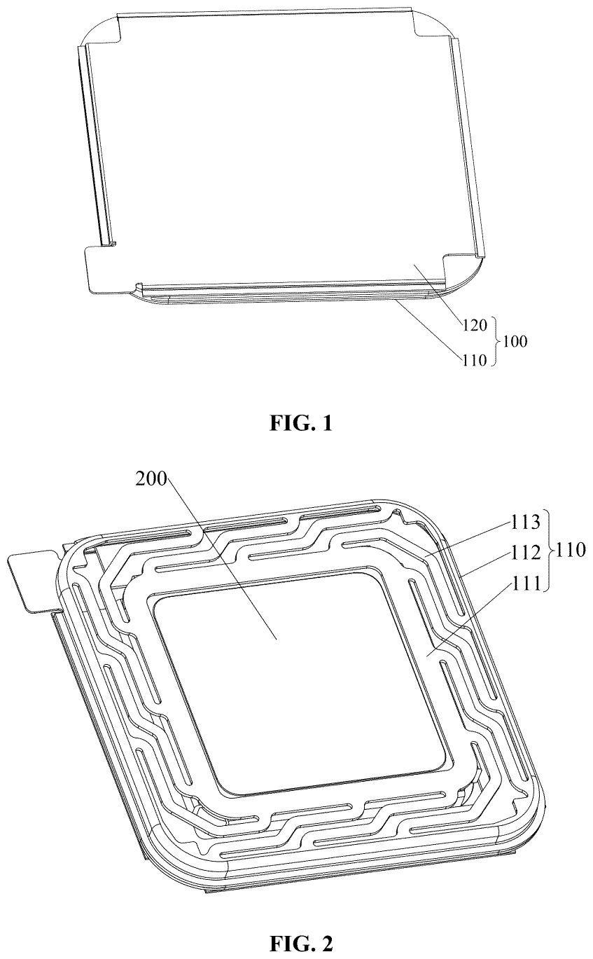

As shown in FIG. 1 to FIG. 5, the vibration exciter includes a housing 100, and a magnetic circuit system 20, a coil 400 and a stopper 500 disposed in the housing 100. The housing 100 has an internal cavity. The magnetic circuit system 20, the coil 400, and the stopper 500 are all disposed in the internal cavity. The housing 100 of this embodiment may be made of a metal material or a non-metal material. This is not limited in this embodiment. The shape of the housing 100 of this embodiment may be determined according to actual applications. For example, the housing 100 may be square, cylindrical, or frustum-shaped. The drawings of this embodiment provide a housing 100 with a square cross section. For ease of understanding, in this embodiment, the thickness direction of the housing 100 is referred to as a first direction X, the length direction of the housing 100 is referred to as a second direction Y, and the width direction of the housing 100 is referred to as a third direction Z. That is, any two of the first direction X, the second direction Y, and the third direction Z are perpendicular to each other.

Illustratively, the housing 100 of this embodiment is a split structure. As shown in FIG. 2, the housing 100 includes a housing body 110 and a cover plate 120. The housing body 110 is an integral structure that can be obtained in one processing process. In addition, the housing body 110 includes a first housing portion 111, a second housing portion 112, and a cantilever structure 113 connected between the first housing portion 111 and the second housing portion 112. The cantilever structure 113 can be elastically deformed so that the relative position between the first housing portion 111 and the second housing portion 112 is variable, thereby providing a condition for vibration of the magnetic circuit system 20. It is to be noted that the cantilever structure 113 of this embodiment may be elastically deformed in the first direction X, or may be elastically deformed in the second direction Y, or may be elastically deformed in the third direction Z. This is not limited in this embodiment.

Illustratively, as shown in FIG. 2 to FIG. 4, the magnetic circuit system 20 is connected to the first housing portion 111 and suspended in the housing through the cantilever structure 113 so that when the magnetic circuit system 20 vibrates, the cantilever structure 113 can be elastically deformed to ensure the normal operation of the vibration exciter. Moreover, the magnetic circuit system 20 has a magnetic gap 10. In this embodiment, one end of the coil 400 is connected to the cover plate 120, and the other end of the coil 400 extends into the magnetic gap 10. After energized, the coil 400 can perform electromagnetic induction with the magnetic circuit system 20. The magnetic circuit system 20 can vibrate relative to the coil 400 under the action of the electromagnetic induction. The magnetic circuit system 20 may vibrate relative to the coil 400 in the first direction X, thereby driving the housing 100 to vibrate in the first direction X. The housing 100 is connected to a vibrable component such as the housing or the screen of the electronic device to implement the vibration feedback of the electronic device.

In the vibration exciter of this disclosure, the housing 100 includes a housing body 110 and a cover plate 120. The housing body 110 includes a first housing portion 111, a second housing portion 112, and a cantilever structure 113 that are integrally formed. The magnetic circuit system 20 is connected to the first housing portion 111 so that the housing body 110 can implement elastic movement between the magnetic circuit system 20, the cover plate 120, and the second housing portion 112 without a separate spring in the housing 100. This is equivalent to integrating an elastically deformable component with a component for supporting the magnetic circuit system 20, thereby reducing the number of components of the vibration exciter without affecting the normal functions of the vibration exciter and thus reducing the structural complexity of the vibration exciter. Thus, the vibration exciter has a simpler structure, involving fewer assembly steps and higher assembly efficiency.

Moreover, due to fewer components of the vibration exciter of this disclosure, the weight of the vibration exciter can be reduced, facilitating the lightweight design of the vibration exciter.

Additionally, in the vibration exciter of this disclosure, the housing body has an improved structure that requires no separate spring, reducing the cost of the vibration exciter.

In this embodiment, the vibration exciter also includes a stopper 500. The stopper 500 is connected to the cover plate 120 and/or the second housing portion 112. That is, the stopper 500 is not directly connected to the cantilever structure 113 or the first housing portion 111. The stopper 500 is spaced apart from the magnetic circuit system 20 in the direction perpendicular to the first direction X and configured to restrict the magnetic circuit system 20 from coming into contact with the coil 400 in the characteristic direction, thereby avoiding a collision between the magnetic circuit system 20 and the coil 400, reducing the risk of displacement of the coil 400, reducing the risk of separation between the coil 400 and the housing 100, and ensuring high reliability. The characteristic direction is perpendicular to the thickness direction of the housing 100 (that is, the first direction X). That is, the characteristic direction may be the second direction Y, or may be the third direction Z, or may include both the second direction Y and the third direction Z. This is determined according to the actual installation position of the magnetic circuit system 20.

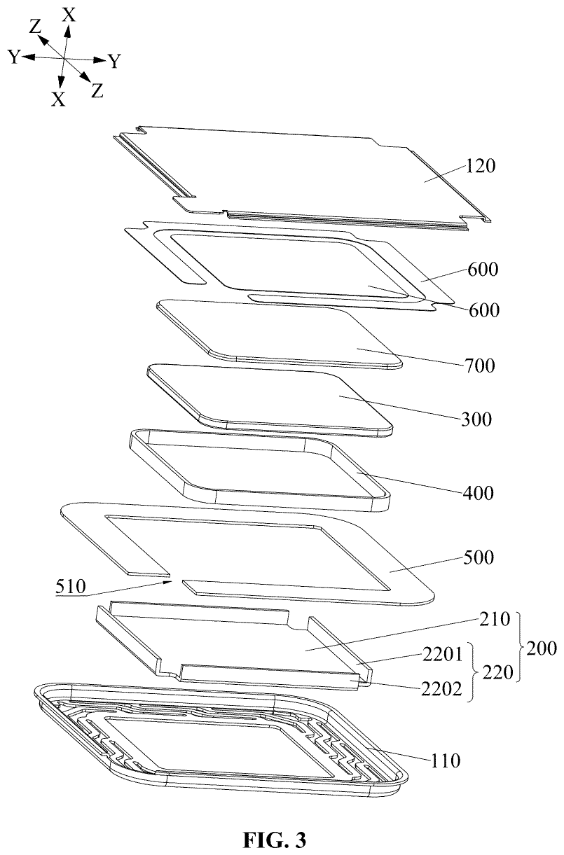

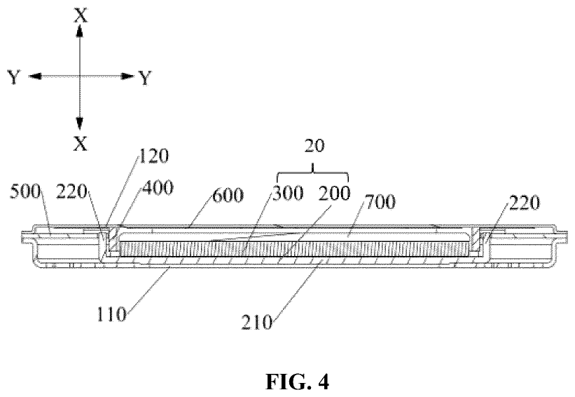

In some embodiments, the magnetic circuit system 20 includes a magnetic yoke 200 and a magnet 300. Illustratively as shown in FIG. 3, the magnetic yoke 200 includes a body portion 210 and multiple extension portions 220. Each extension portion 220 is connected to the body portion 210 at an angle. As shown in FIG. 4, the included angle between the body portion 210 and each extension portion 220 may be equal to 90 degrees, that is, the body portion 210 is perpendicularly connected to the extension portions 220. In other embodiments, the included angle between the body portion 210 and an extension portion 220 may also be greater than or less than 90 degrees. This is not limited in this embodiment. The extension portions 220 of this embodiment are connected to the edges of the body portion 210. The extension portions 220 are spaced apart along the circumferential direction of the body portion 210.

Illustratively, as shown in FIG. 4, the body portion 210 is connected to the first housing portion 111 to achieve connection between the magnetic yoke 200 and the housing 100. The magnet 300 of this embodiment is connected to the body portion 210 so that the magnet 300 can be connected to the first housing portion 111 by the magnetic yoke 200. In addition, in the characteristic direction, the magnet 300 and the extension portions 220 are spaced apart and opposite to each other to cooperate with the extension portions 220 to form the magnetic gap 10. For example, one surface of the body portion 210 in the first direction X is connected to the magnet 300, and the other surface of the body portion 210 in the first direction X is connected to the housing 100, thereby fully using the space in the housing 100.

In an embodiment, the stopper 500 is disposed on the side of the extension portions 220 away from the magnet 300 and configured to restrict the extension portions 220 from coming into contact with the coil 400 in the characteristic direction. In this manner, when the extension portions 220 move relative to the coil 400 in the direction perpendicular to the first direction X, the extension portions 220 do not come into contact with the coil 400.

In other embodiments, the stopper 500 may also be disposed on the side of the extension portions 220 facing the magnet 300 and configured to restrict the extension portions 220 from coming into contact with the coil 400. This is not limited in this embodiment.

It is to be noted that the position of the stopper 500 matches the position of the extension portions 220, preventing the extension portions 220 from coming into contact with the coil 400.

Illustratively, as shown in FIG. 3, the extension portions 220 include two extension portions 220 opposite in the second direction Y and two extension portions 220 opposite in the third direction Z. The stopper 500 is annular. The extension portions 220 are all located in the ring of the stopper 500. That is, the stopper 500 surrounds the extension portions 220. The inner ring surface of the stopper 500 can come into contact with the extension portions 220. When the stopper 500 comes into contact with one extension portion 220 in the second direction Y, the other extension portion 220 in the second direction Y can be restricted from coming into contact with the coil 400. When the stopper 500 comes into contact with one extension portion 220 in the third direction Z, the other extension portion 220 in the third direction Z can be restricted from coming into contact with the coil 400. This limits the movement of the extension portions 220 in the second direction Y and the third direction Z, thereby limiting the maximum distance between the extension portions 220 and the magnetic circuit system 20, preventing the extension portions 220 from coming into contact with the coil 400, and ensuring higher reliability.

It is to be noted that to avoid the lead-out wire of the coil 400, in this embodiment, as shown in FIG. 3, the stopper 500 has a notch 510 configured for the lead-out wire of the coil 400 to pass through. Of course, it can be understood that the stopper 500 may also be provided with a shallow groove instead of a notch 510. This is not limited in this embodiment.

The stopper 500 may have various structures. This embodiment provides the stopper 500 having the following two structures:

In one structure of the stopper 500, the stopper 500 is sheet-shaped, and the large surface of the stopper 500 is perpendicular to the first direction X, that is, the stopper 500 is perpendicular to the extension portions 220. In this manner, the inner side of the stopper 500 is configured to abut against the extension portions 220, and the outer side of the stopper 500 is configured to be connected to the second housing portion 112 or the cover plate 120. In some embodiments, as shown in FIG. 4, the outer side of the stopper 500 is sandwiched between the housing body 110 and the cover plate 120.

In the other structure of the stopper 500, the stopper 500 is columnar, and the axial direction of the stopper 500 is the first direction X, that is, the axial direction of the stopper 500 is the same as the extension direction of the extension portions 220. One end of the stopper 500 in the axial direction of the stopper 500 is connected to the cover plate 120, and the other end of the stopper 500 is configured to abut against the extension portions 220.

The stopper 500 having the above two structures can limit the positions of the extension portions 220 to restrict the extension portions 220 from coming into contact with the coil 400.

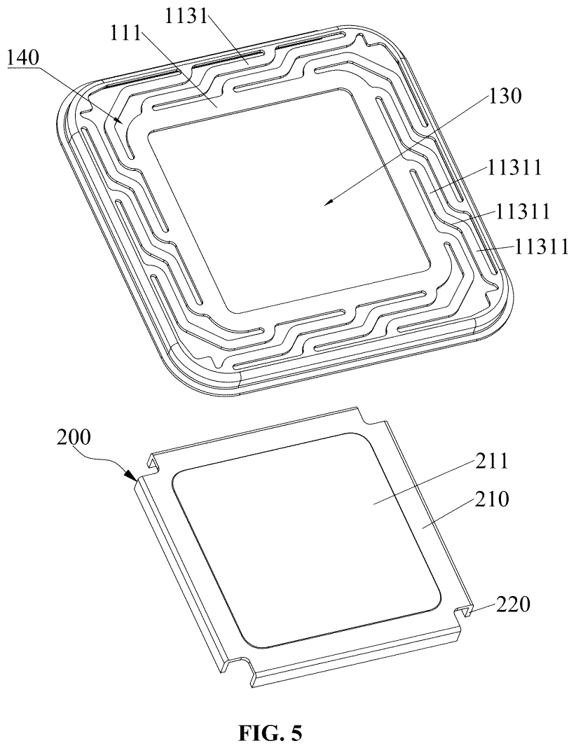

The cantilever structure 113 may have various structures. This embodiment provides a cantilever structure 113. Illustratively, as shown in FIG. 5, the cantilever structure 113 includes multiple first deformable members 1131. The first deformable members 1131 are spaced apart along the circumferential direction of the first housing portion 111. One end of each first deformable member 1131 is connected to the first housing portion 111. The other end of each first deformable member 1131 is connected to the second housing portion 112. The first deformable members 1131 can be elastically deformed. With the first deformable members 1131, on the one hand, the connection strength and connection reliability of the first housing portion 111 and the second housing portion 112 can be ensured, and on the other hand, the deformation capability of the cantilever structure 113 can be improved, thereby increasing the movement range of the first housing portion 111 relative to the second housing portion 112 and improving the vibration amplitude of the magnetic circuit system 20.

It is to be noted that the first deformable members 1131 may be elastically deformed in the first direction X or may be elastically deformed in the second direction Y or the third direction Z to buffer forces from different directions. The first deformable members 1131 have a high buffering capability. The first deformable members 1131 of this embodiment are all arranged in the same layer as the housing body 110. The top surfaces (or bottom surfaces) of the first deformable members 1131 are coplanar with the top surface (or bottom surface) of the housing body 110. Thus, on the basis of ensuring the buffering performance, the housing 100 occupies a small space in the first direction X, facilitating the lightness and thinness of the vibration exciter.

Illustratively as shown in FIG. 5, a through hole 140 is formed by being enclosed by the first housing portion 111, the second housing portion 112, and two adjacent deformable portions 11311 in the circumferential direction of the first housing portion 111. The through hole 140 provides a movement space for the first deformable member 1131 to ensure the buffering performance and the suction performance of the cantilever structure 113.

The first deformable member 1131 may have various structures. This embodiment provides a first deformable member 1131. As shown in FIG. 5, the first deformable member 1131 includes at least two deformable portions 11311 connected end to end. Two connected deformable portions 11311 are disposed at an obtuse angle. In this manner, with the deformable portions 11311, the length of the first deformable member 1131 may be longer so that the first deformable member 1131 has a larger deformation amplitude in the first direction X, better improving the buffering performance of the cantilever structure 113 and improving the anti-collision capability of the vibration exciter. In addition, the two deformable portions 11311 connected to each other are disposed at an obtuse angle so that the size of the first deformable member 1131 in the direction perpendicular to the first direction X (for example, the second direction Y or the third direction Z) is not excessively large so that both the length and the width of the vibration exciter can be relatively small, thereby facilitating miniaturization of the vibration exciter.

To better increase the number of first deformable members 1131 between the first housing portion 111 and the second housing portion 112, in an embodiment, the connection position between each first deformable member 1131 and the first housing portion 111 is a first connection position, the connection position between each first deformable member 1131 and the second housing portion 112 is a second connection position, and the first connection position and the second connection position are staggered in the characteristic direction, that is, the first connection position and the second connection position corresponding to one first deformable member 1131 are not opposite in both the second direction Y and the third direction Z. In this manner, on the premise of ensuring a relatively long length of each first deformable member 1131, the first deformable members 1131 can be in concave-convex fit so that the first deformable members 1131 can be disposed in a small space and so that the first deformable members 1131 can be arranged regularly.

In one or more embodiments, the cover plate 120 may be made of ferromagnetic stainless steel, copper, or other non-magnetic alloys. The housing body 110 may be made of stainless steel such as SUS304 or SUS430F so that the housing body 110 has the functions of both strength and elastic buffering. The housing body 110 may be magnetic or may not be magnetic. This is not limited in this embodiment.

In some embodiments, to better reduce the weight of the vibration exciter, as shown in FIG. 5, the first housing portion 111 of the housing body 110 is provided with a hollow hole 130, the surface of the body portion 210 of the magnetic yoke 200 away from the extension portions 220 is provided with a protrusion 211, and the protrusion 211 extends into the hollow hole 130. The hollow hole 130 can reduce the weight of the first housing portion 111 and improve the lightweight design of the vibration exciter. The protrusion 211 extending into the hollow hole 130 can facilitate the alignment and installation of the magnetic yoke 200 and the first housing portion 111 and reduce the assembly difficulty of the magnetic yoke 200 and the housing 100.

To better improve the anti-collision capability of the vibration exciter, as shown in FIG. 3 and FIG. 4, the vibration exciter also includes a buffer layer 600. The buffer layer 600 has an energy absorption and buffering function.

Illustratively, a buffer layer 600 is disposed between the magnetic circuit system 20 and the cover plate 120 so that the buffer layer 600 can buffer impact between the magnetic circuit system 20 and the cover plate 120, preventing the magnetic circuit system 20 from directly colliding with the cover plate 120, reducing the risk of damage to the magnetic circuit system 20, and preventing the cover plate 120 from having a pit due to the impact and thus affecting the appearance of the vibration exciter.

In one or more embodiments, the buffer layer 600 may be made of an elastic material. Illustratively, the buffer layer 600 may include one or more layers. For example, the buffer layer 600 includes a buffer material layer and an anti-adhesion layer. The buffer material layer may be made of pressure-sensitive double-sided adhesive (PSA). The anti-adhesion layer may be made of thermoplastic polyester (PET). The buffer material layer functions as a buffer. The anti-adhesion layer is configured for anti-adhesion of the buffer layer 600.

In an embodiment, as shown in FIG. 4, the buffer layer 600 is connected to the inner wall of the cover plate 120 and spaced apart from the magnetic circuit system 20. In this manner, the buffer layer 600 can prevent the magnetic circuit system 20 from directly colliding with the cover plate 120 without increasing the weight of the magnetic circuit system 20.

In other embodiments, the buffer layer 600 is connected to the magnetic circuit system 20 and spaced apart from the cover plate 120, also preventing the magnetic circuit system 20 from directly colliding with the cover plate 120.

In some embodiments, as shown in FIG. 3, the magnetic circuit system 20 also includes a magnetic conductive member 700 disposed on a side of the magnet 300 away from the magnetic yoke 200. A buffer layer 600 is disposed between the magnetic conductive member 700 and the cover plate 120.

It is to be noted that a buffer layer 600 may also be disposed between the extension portions 220 and the cover plate 120 to prevent the extension portions 220 from directly colliding with the cover plate 120.

In the vibration exciter of this embodiment, the first housing portion 111, the second housing portion 112, and the cantilever structure 113 form an integral structure. Compared with a split structure, the vibration exciter has a stronger overall structural strength and is more resistant to drop, roller, and other strength test experiments. The integral elastic structure reduces the number of other parts and simplifies the assembly process of the vibration exciter, thereby reducing the material cost, improving the product yield, and greatly reducing the price cost of the entire product. The inner side of the cover plate 120 of this embodiment is attached to the buffer layer 600, greatly improving the safety against drop impact.

### Embodiment Two

This embodiment provides a vibration exciter. This embodiment differs from embodiment one in the structure of the stopper 500.

As shown in FIG. 3, the extension portions 220 of this embodiment include two first extension portions 2201 opposite in the second direction Y and two second extension portions 2202 opposite in the third direction Z. Multiple stoppers 500 are provided. Two opposite sides of the two first extension portions 2201 are each provided with at least one stopper 500. Two opposite sides of the two second extension portions 2202 are each provided with at least one stopper 500. In an embodiment, each stopper 500 is split, and the stoppers 500 include two first stoppers (not shown) and two second stoppers (not shown). The two first stoppers are disposed on the opposite sides of the two first extension portions 2201 and are opposite to the two first extension portions 2201 one to one in the second direction Y. The two second stoppers are disposed on the opposite sides of the two second extension portions 2202 and are opposite to the two second extension portions 2202 one to one in the third direction Z.

When one first stopper in the second direction Y comes into contact with the corresponding first extension portion 2201, the other first extension portion 2201 in the second direction Y can be restricted from colliding with the coil 400. When one second stopper in the third direction Z comes into contact with the corresponding second extension portion 2202, the other second extension portion 2202 in the third direction Z can be restricted from colliding with the coil 400. This limits the movement of the extension portions 220 in the second direction Y and the third direction Z, thereby limiting the maximum distance between the extension portions 220 and the magnetic circuit system 20, preventing the extension portions 220 from colliding with the coil 400, and ensuring high reliability.

Other structures of this embodiment are similar to the corresponding structures of embodiment one and have similar beneficial effects. The details are not described here again.

### Embodiment Three

This embodiment provides a vibration exciter. This embodiment differs from embodiment one and embodiment two in the structure of the magnetic yoke 200.

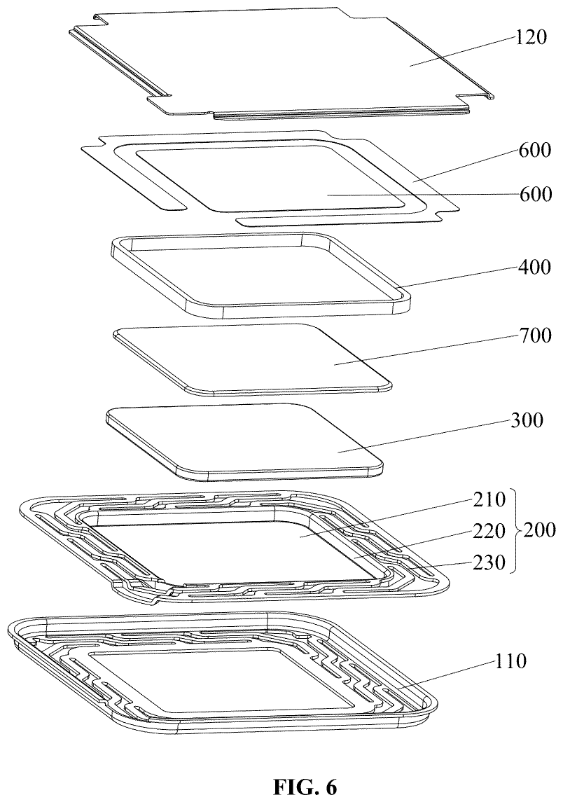

In this embodiment, as shown in FIG. 6 to FIG. 8, the extension portions 220 of the magnetic yoke 200 are connected in sequence into an annular whole. In addition, as shown in FIG. 6 to FIG. 8, the magnetic yoke 200 also includes a deformable structure 230 that can be elastically deformed. The extension portions 220 are connected to the housing 100 by the deformable structure 230. In this embodiment, the deformable structure 230 may be connected to at least one of the first housing portion 111 or the second housing portion 112. This is not limited in this embodiment.

In one or more embodiments, the deformable structure 230 may have various structures. This embodiment provides the deformable structure 230 having the following two structures:

In one embodiment of the deformable structure 230, as shown in FIG. 8, the deformable structure 230 includes an annular portion 231 and multiple second deformable members 232. The second deformable members 232 are spaced apart along the circumferential direction of the body portion 210. For each second deformable member 232, one end of the second deformable member 232 is connected to the extension portions 220, and the other end of the second deformable member 232 is connected to the annular portion 231. The second deformable members 232 are elastically deformable. The annular portion 231 is connected to the housing 100.

It is to be noted that the second deformable members 232 may be elastically deformed in the first direction X or may be elastically deformed in the direction perpendicular to the first direction X (that is, the second direction Y and the third direction Z) to buffer forces from different directions. The second deformable members 232 have a relatively high buffering capability. The second deformable members 232 of this embodiment are all arranged in the same layer as the annular portion 231. Thus, on the basis of ensuring the buffering performance, the space occupied by the magnetic yoke 200 in the first direction X is small, facilitating the lightness and thinness of the vibration exciter.

Illustratively, a hole structure is formed by being enclosed by two adjacent second deformable members 232 in the circumferential direction of the body portion 210, the extension portions 220, and the annular portion 231. The hole structure provides a movement space for the second deformable members 232 to ensure the buffering performance and the suction performance of the deformable structure 230.

The second deformable member 232 may have various structures. This embodiment provides a second deformable member 232. As shown in FIG. 8, the second deformable member 232 includes at least two energy absorption portions 2321 connected end to end. Two connected energy absorption portions 2321 are disposed at an obtuse angle. In this manner, with the energy absorption portions 2321, the length of the second deformable member 232 can be longer so that the second deformable member 232 has a larger deformation amplitude in the first direction X, better improving the buffering performance of the deformable structure 230 and improving the anti-collision capability of the vibration exciter. In addition, the two energy absorption portions 2321 connected to each other are disposed at an obtuse angle so that the size of the second deformable member 232 in the direction perpendicular to the first direction X is not excessively large so that both the length and the width of the vibration exciter can be relatively small, thereby facilitating miniaturization of the vibration exciter.

To better increase the number of second deformable members 232 between the extension portions 220 and the annular portion 231, in one or more embodiments, the connection position between each second deformable member 232 and the extension portions 220 is a third connection position, the connection position between each second deformable member 232 and the annular portion 231 is a fourth connection position, and the third connection position and the fourth connection position are staggered in a direction perpendicular to the first direction X, that is, the third connection position and the fourth connection position corresponding to one second deformable member 232 are not opposite in both the second direction Y and the third direction Z. In this manner, on the premise of ensuring a relatively long length of each second deformable member 232, the second deformable members 232 can be in concave-convex fit so that the second deformable members 232 can be disposed in a small space and so that the second deformable members 232 can be arranged regularly.

In another embodiment of the deformable structure 230, the deformable structure 230 may be provided with no annular portion 231. The deformable structure 230 includes multiple connectors (not shown). The connectors are spaced apart along the circumferential direction of the body portion 210. For each connector, one end of the connector is connected to the extension portion 220, and the other end of the connector is connected to the housing 100. The connectors are elastically deformable. In this manner, the buffering performance and the suction performance of the deformable structure 230 can be implemented through elastic deformation of the connectors. It is to be noted that the shape of the connectors may be similar to the shape of the second deformable members 232. For example, each connector includes at least two connecting portions connected end to end. Two connected connecting portions are arranged at an obtuse angle so that the connector can be longer.

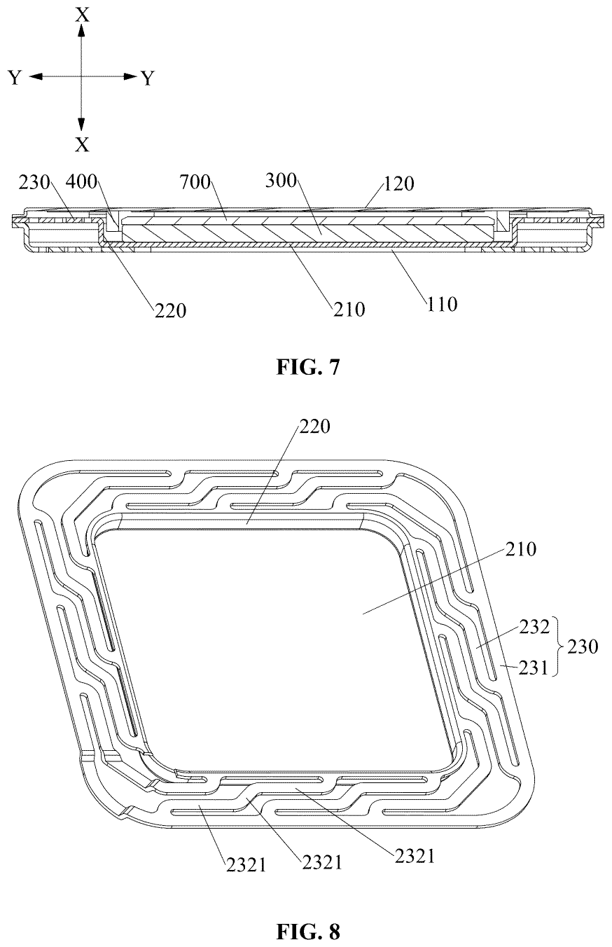

It is to be noted that, as shown in FIG. 7, the deformable structure 230 and the cantilever structure 113 are opposite in the first direction X so that the vibration exciter is a double-layer elastic structure. This increases the rotational rigidity of the vibration exciter, thereby suppressing swinging of the vibration exciter, reducing the magnetic gap 10 of the magnetic circuit system 20, and improving the reliability and vibration performance of the vibration exciter.

To better reduce the number of components of the vibration exciter, in an embodiment, the deformable structure 230 and the extension portions 220 are an integral structure. This reduces the number of components, thereby simplifying the assembly process of the vibration exciter, reducing the material cost, improving the product yield, and greatly reducing the cost of the entire vibration exciter.

It is to be noted that the second deformable members 232 and the stopper 500 may be opposite in the first direction X without interfering with each other. For example, the second deformable member 232 may be closer to the cover plate 120 than the stopper 500 or may be sandwiched between the cover plate 120 and the second housing portion 112. This is not limited in this embodiment.

When the second deformable member 232 is disposed on a side of the stopper 500 facing the cover plate 120, a buffer layer 600 may be disposed between the deformable structure 230 and the cover plate 120 to prevent the deformable structure 230 from directly colliding with the cover plate 120.

Other structures of this embodiment are similar to the corresponding structures of embodiment one or embodiment two and have similar beneficial effects. The details are not described here again.

### Embodiment Four

This embodiment provides a vibration exciter. This embodiment differs from embodiment three in that the deformable structure 230 and the extension portions 220 are not an integral structure, but separate structures.

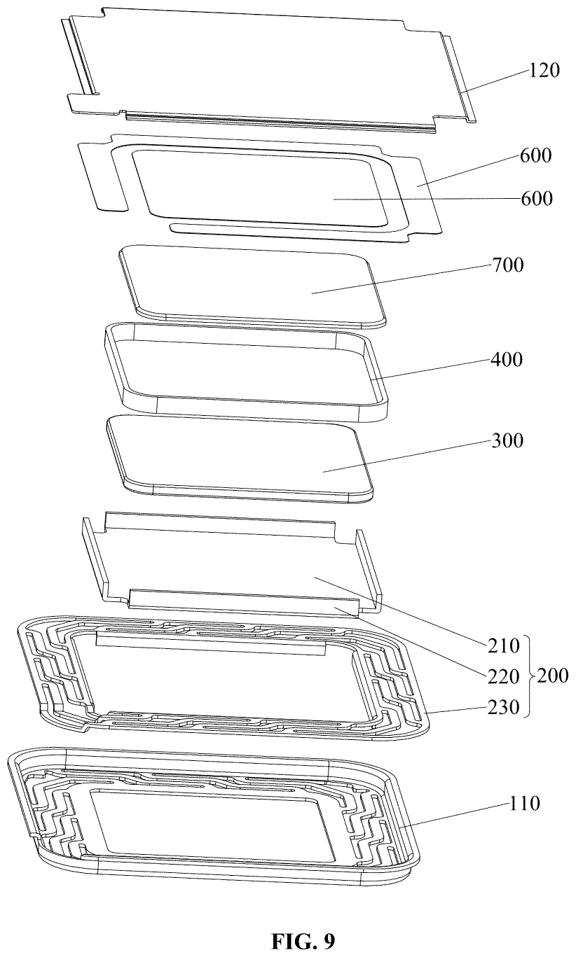

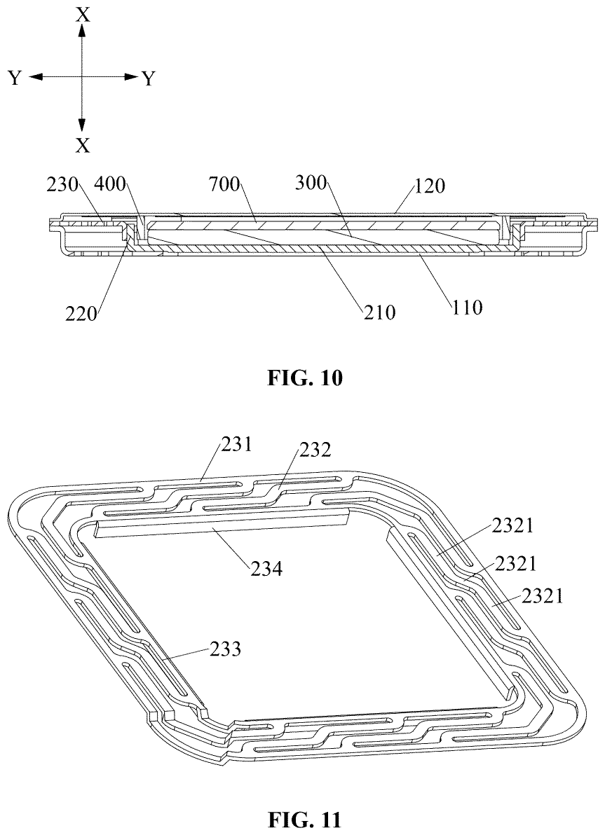

As shown in FIG. 9 to FIG. 11, the deformable structure 230 is connected to a surface of each extension portion 220 away from the coil 400. In this manner, the extension portions 220 can also be connected to the housing 100.

In some embodiments, on the basis of embodiment three, the deformable structure 230 includes not only the annular portion 231 and the energy absorption portion 2321, as shown in FIG. 11, but also an annular inner ring portion 233 and fitting portions 234 connected to the inner ring portion 233. The inner ring portion 233 and the annular portion 231 are disposed in the same layer. The second deformable members 232 are connected between the inner ring portion 233 and the annular portion 231. The fitting portions 234 extend along the first direction X and are connected to the inner ring portion 233. A fitting portion 234 is attached to and connected to an extension portion 220 to have a relatively large connection area, thereby improving the connection reliability.

In this embodiment, the fitting portions 234 are made of a magnetic material, for example, low carbon steel (steel plate cold rolled commercial (SPCC)) or cold rolled steel (steel plate cold rolled grade G (SPCG)). Thus, the magnetic circuit system 20 has a relatively large number of magnetic components, thereby improving the magnetic induction intensity of the vibration exciter. In this case, the deformable structure 230 may be made of 304 stainless steel.

Other structures of this embodiment are similar to the corresponding structures of embodiment three and have similar beneficial effects. The details are not described here again.

### Embodiment Five

This embodiment provides a vibration exciter. This embodiment differs from embodiment one, embodiment two, embodiment three, and embodiment four in the connection relationship of the buffer layer 600.

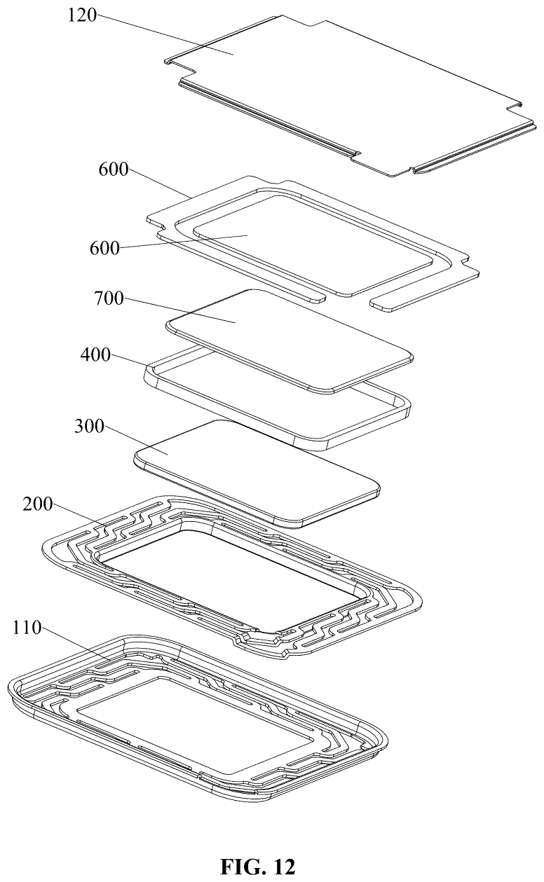

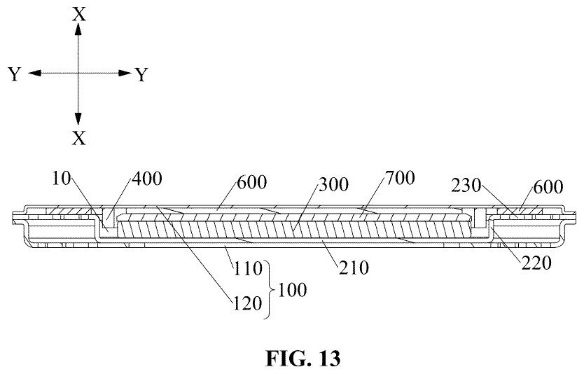

As shown in FIG. 12 and FIG. 13, the buffer layer 600 of this embodiment comes into contact with both the magnetic circuit system 20 and the cover plate 120. The buffer layer 600 of this embodiment is elastic. The buffer layer 600 comes into contact with both the inner wall of the cover plate 120 and the magnetic conductive member 700 of the magnetic circuit system 20. The elastic buffer layer 600 does not interfere with the movement of the magnetic circuit system 20 in the first direction X, thereby ensuring the generation and transmission of vibration.

Other structures of this embodiment are similar to the corresponding structures of embodiments one, two, three, and four and have similar beneficial effects. The details are not described here again.

It is to be noted that the preceding are alternative embodiments of this disclosure and technical principles used therein. It is to be understood by those skilled in the art that this disclosure is not limited to the embodiments described herein. For those skilled in the art, various apparent modifications, adaptations, and substitutions can be made without departing from the scope of this disclosure. Therefore, while this disclosure is described in detail in conjunction with the preceding embodiments, this disclosure is not limited to the preceding embodiments and may further include more other equivalent embodiments without departing from the concept of this disclosure. The scope of this disclosure is determined by the scope of the appended claims.

What is claimed is:

1. A vibration exciter, comprising:
a housing, comprising a housing body and a cover plate, wherein the housing body is an integral structure, the housing body comprises a first housing portion, a second housing portion, and a cantilever structure connected between the first housing portion and the second housing portion, the cantilever structure is elastically deformable, and the cover plate is connected to the second housing portion;
a magnetic circuit system connected to the first housing portion, wherein the magnetic circuit system is suspended in the housing through the cantilever structure, and the magnetic circuit system has a magnetic gap; and
a coil disposed in the housing, wherein one end of the coil in an axial direction of the coil is connected to the cover plate, the other end of the coil in the axial direction of the coil extends into the magnetic gap, and the magnetic circuit system is configured to vibrate relative to the coil.

2. The vibration exciter of claim 1, further comprising a stopper, wherein the stopper is connected to at least one of the cover plate or the second housing portion, the stopper is spaced apart from the magnetic circuit system and is configured to restrict the magnetic circuit system from coming into contact with the coil in a characteristic direction, and the characteristic direction is perpendicular to a thickness direction of the housing.

3. The vibration exciter of claim 2, wherein the magnetic circuit system comprises a magnetic yoke and a magnet, wherein
the magnetic yoke comprises a body portion and a plurality of extension portions, each of the plurality of extension portions is connected to the body portion at an angle, the plurality of extension portions are spaced apart along a circumferential direction of the body portion, and the body portion is connected to the first housing portion; the magnet is connected to the body portion and cooperates with the plurality of extension portions to form the magnetic gap, the stopper is disposed on a side of the plurality of extension portions away from the magnet, and the stopper is configured to restrict the plurality of extension portions from coming into contact with the coil in the characteristic direction.

4. The vibration exciter of claim 3, wherein the plurality of extension portions comprise two extension portions opposite in a second direction and two extension portions opposite in a third direction; and
the stopper is annular, the plurality of extension portions are located in a ring of the stopper, and an inner ring surface of the stopper is configured to come into contact with the plurality of extension portions to limit a maximum distance between the plurality of extension portions and the coil.

5. The vibration exciter of claim 3, wherein the plurality of extension portions comprise two first extension portions opposite in a second direction and two second extension portions opposite in a third direction, a plurality of stoppers are provided, two sides of the two first extension portions opposite in the second direction are each provided with at least one of the plurality of stoppers, and two sides of the two second extension portions opposite in the third direction are each provided with at least one of the plurality of stoppers.

6. The vibration exciter of claim 5, wherein the plurality of stoppers comprise two first stoppers and two second stoppers, the two first stoppers are disposed on the opposite sides of the two first extension portions and are opposite to the two first extension portions one to one in the second direction; the two second stoppers are disposed on the opposite sides of the two second extension portions and are opposite to the two second extension portions one to one in the third direction.

7. The vibration exciter of claim 1, wherein the cantilever structure comprises a plurality of first deformable members spaced apart along a circumferential direction of the first housing portion, wherein for each of the plurality of first deformable members, one end of the first deformable member is connected to the first housing portion, the other end of the first deformable member is connected to the second housing portion, and the first deformable member is elastically deformable.

8. The vibration exciter of claim 7, wherein a connection position between each of the plurality of first deformable members and the first housing portion is a first connection position, a connection position between each of the plurality of first deformable members and the second housing portion is a second connection position, and the first connection position and the second connection position are staggered in the characteristic direction.

9. The vibration exciter of claim 7, wherein the plurality of first deformable members are arranged in a same layer as the first housing portion.

10. The vibration exciter of claim 7, wherein a first deformable member of the plurality of first deformable members comprises at least two deformable portions connected end to end, and two connected deformable portions of the at least two deformable portions are disposed at an obtuse angle.

11. The vibration exciter of claim 3, wherein the magnetic yoke further comprises a deformable structure, and the plurality of extension portions are connected to the housing by the deformable structure.

12. The vibration exciter of claim 11, wherein the deformable structure and the plurality of extension portions are an integral structure, or the deformable structure is connected to a surface of the plurality of extension portions away from the coil.

13. The vibration exciter of claim 11, wherein the deformable structure comprises an annular portion and a plurality of second deformable members, the plurality of second deformable members are spaced apart along a circumferential direction of the body portion, for each of the plurality of second deformable members, one end of the second deformable member is connected to the extension portions, the other end of the second deformable member is connected to the annular portion, the plurality of second deformable members are elastically deformable, and the annular portion is connected to the housing.

14. The vibration exciter of claim 13, wherein a connection position between each of the plurality of second deformable members and the plurality of extension portions is a third connection position, a connection position between each of the plurality of second deformable members and the annular portion is a fourth connection position, and the third connection position and the fourth connection position are staggered in a direction perpendicular to the characteristic direction.

15. The vibration exciter of claim 11, wherein the deformable structure comprises a plurality of connectors, the plurality of connectors are spaced apart along a circumferential direction of the body portion, for each of the plurality of connectors, one end of the connector is connected to the extension portions, the other end of the connector is connected to the housing, and the plurality of connectors are elastically deformable.

16. The vibration exciter of claim 13, wherein a second deformable member of the plurality of second deformable members comprises at least two energy absorption portions connected end to end, and two connected energy absorption portions of the at least two energy absorption portions are disposed at an obtuse angle.

17. The vibration exciter of claim 1, further comprising a buffer layer disposed between the magnetic circuit system and the cover plate, wherein the buffer layer is connected to at least one of the magnetic circuit system or the cover plate.

18. The vibration exciter of claim 17, wherein the magnetic circuit system further comprises a magnetic conductive member, and the buffer layer is disposed between the magnetic conductive member and the cover plate.

19. The vibration exciter of claim 3, wherein the first housing portion is provided with a hollow hole, a surface of the body portion away from the plurality of extension portions is provided with a protrusion, and the protrusion extends into the hollow hole.

20. The vibration exciter of claim 2, wherein the stopper is provided with a notch or a shallow groove configured to avoid a lead-out wire of the coil.
